(19) United States
(12) Patent Application Publication
(10) Pub. No.: US 2009/0052446 A1
(43) Pub. Date: Feb. 26, 2009

(54) Communications Interface

(76) Inventor: Nicholas Farrow, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 11/991,079

(22) PCT Filed: Sep. 6, 2006
(86) PCT No.: PCT/GB2006/003300

§ 371 Date: Feb. 27, 2008

(30) Foreign Application Priority Data
Sep. 6, 2005 (EP) 05255447.4

(51) Int. Cl. H04L 12/28

(52) U.S. Cl. 370/389

(57) ABSTRACT

At an access point (1) to the internet (2) a controller (8) reduces the header data received with datagrams to a minimal header for transmission across a Bluetooth interface to a mobile device. This is achieved by establishing a link identity for each communication series between a mobile device (7) and a remote IP node (3, 4). By using a minimal header across the Bluetooth link it is possible to transfer datagrams received or transmitted by the mobile device much faster than would be the case if the full header required across the internet is used.

The present invention relates to a communications interface and a method of operating such a communications interface.

As access to the internet improves and there is increasing use of voice over the internet using VoiP for communication and the use of small portable devices for playing games programs and downloading or manipulating date, the problem of interfacing with such devices over the final link may have an adverse effect on the user's experience. Developing technologies now allows data to be transferred at very high speeds across both connection oriented (e.g. the PSTN) and connectionless networks (e.g. the Internet). In many cases the final access point of the network per se is a wireless link which may be a public access radio point such as are often provided in offices, coffee shops and shopping malls to enable people to use laptops, PPCs (for example Hewlett- Packard IPAQ ™) and other devices to communicate by way of the Internet or World Wide Web. The availability of such communication capabilities and the development of increasingly sophisticated mobile phones having the capability of using video, data and programmes as well as voice means that the end-user may access and transfer very large data files and/or time critical data such as VoiP or video in telephony.

At the final link between the network access point and the mobile phone or ppc there may be significant bandwidth limitations if the connection between the mobile device and the access point is for example Bluetooth and other low power radio or via an infra red port for example.

This may result in significant loss of data messages when the connection requires to handle multiple connections or high intensity data messages across the connection and it is accordingly necessary to make the most efficient use possible of the final link.

According to the present invention there is provided a method of operating a communication interface at a final link between a communications network and an end user device comprising the steps of

For each series of contiguous data messages establishing a link identification between the communication interface and the device;

Storing at the interface a mapping of the link identification to source and destination addresses;

For each addressed message received from the device replacing link identification information with header information corresponding to the destination; and

For each message received from a source replacing header information with link identification information

whereby the ratio of data payload to destination data of data messages in the final link is substantially improved.

According to a second aspect of the invention there is provided a communications interface at a final link between a communications network and an end user device, the interface comprising a wireless transceiver for sending data messages to and receiving data messages from the end user device, a high speed connection to a communications network for sending and receiving data messages to remote devices, and a controller, the controller establishing for each contiguous series of data messages between the end user device and a remote device a first address for messages to or from the end user device and a second address for the remote device the controller storing a mapping between the first address and the second address and on receipt of a data message from the end user device substituting the second address for the first address, and on receipt of a data message for the end user device substituting the first address for the second address, the first address comprising substantially less data than the second address whereby data payload of each message transferred over the final link to the end user device is maximised.

A communications interface in accordance with the invention will now be described by way of example only with reference to the accompanying drawings of which:

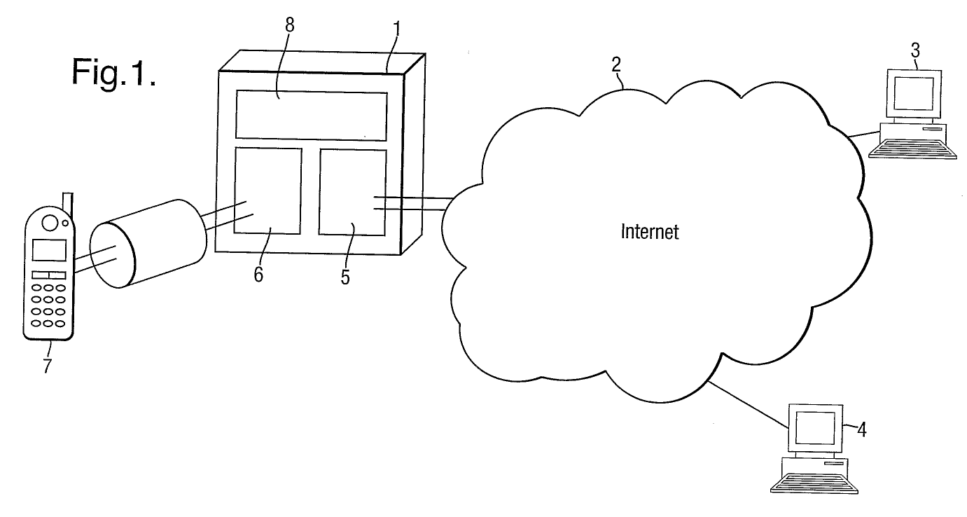

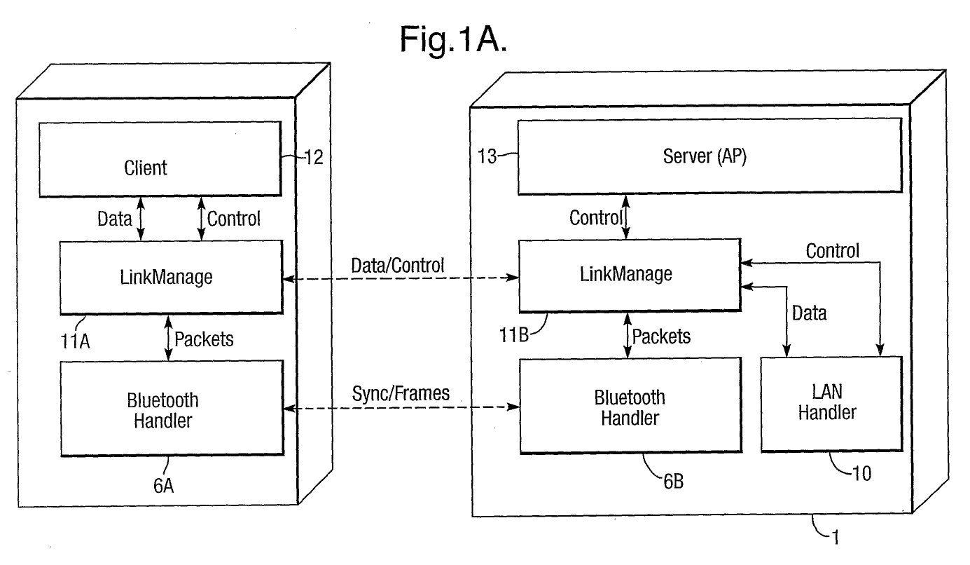

FIG. 1 is a block schematic diagram showing the interface in a communications system;

FIG. 1A shows a part of FIG. 1 in greater detail;

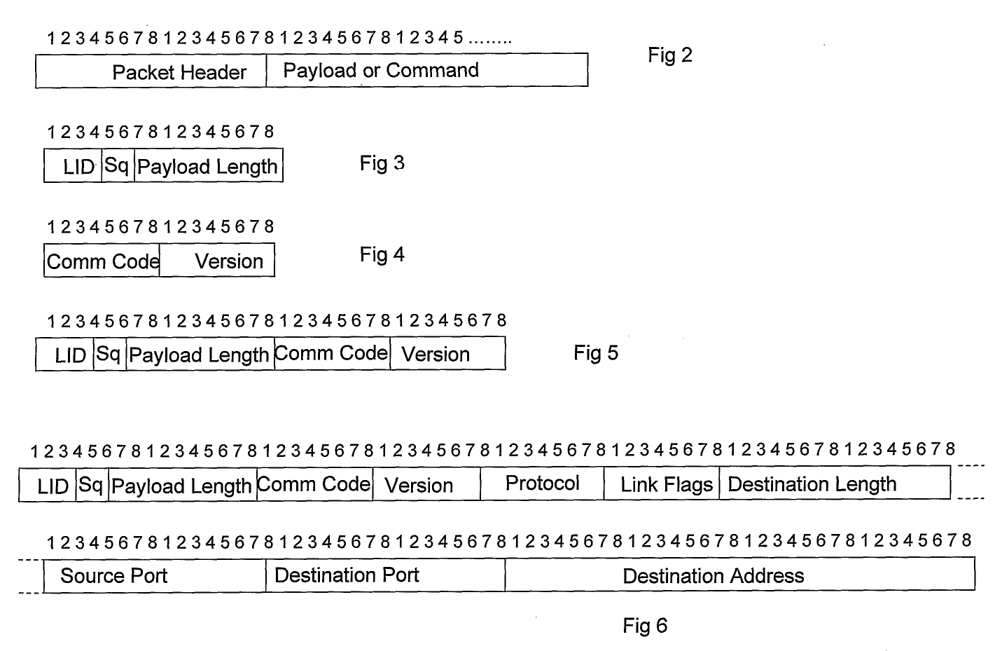

FIGS. 2 to 9 show message (datagram) structures during various phases of the operation of the interface;

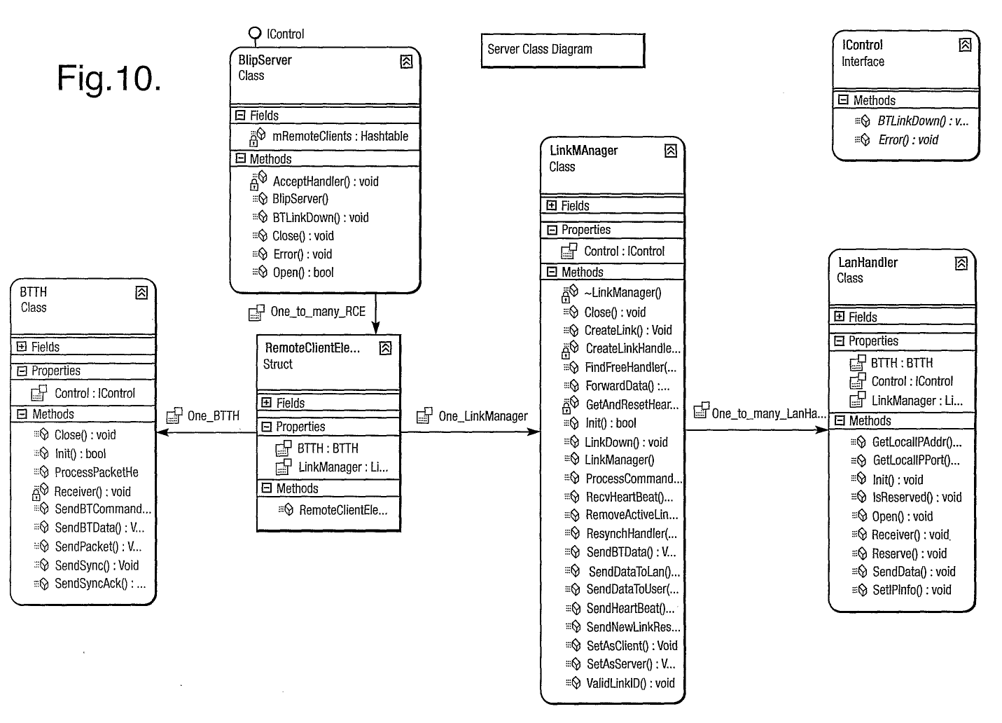

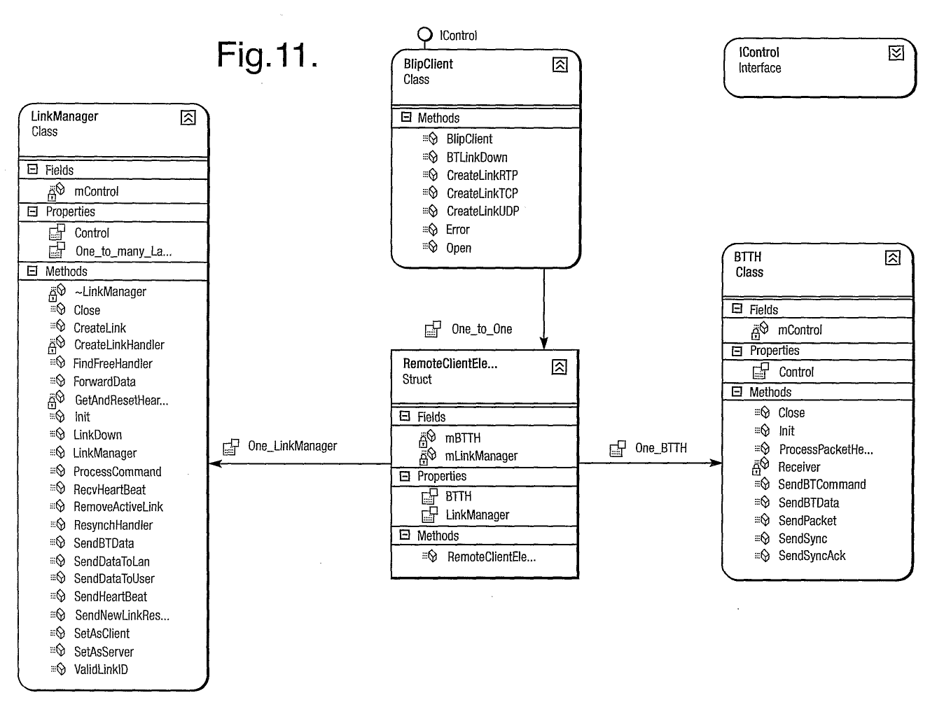

FIGS. 10 and 11 are class diagrams for the server and the mobile device respectively; and

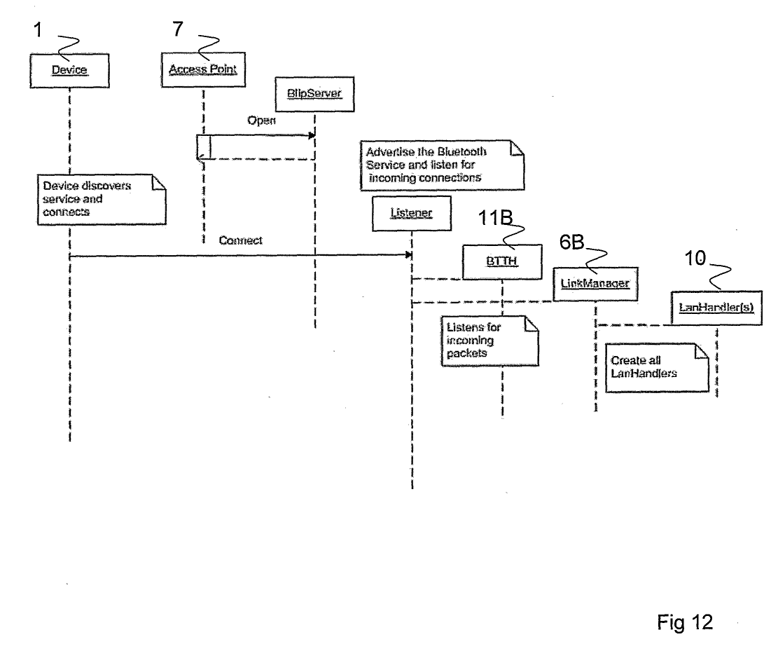

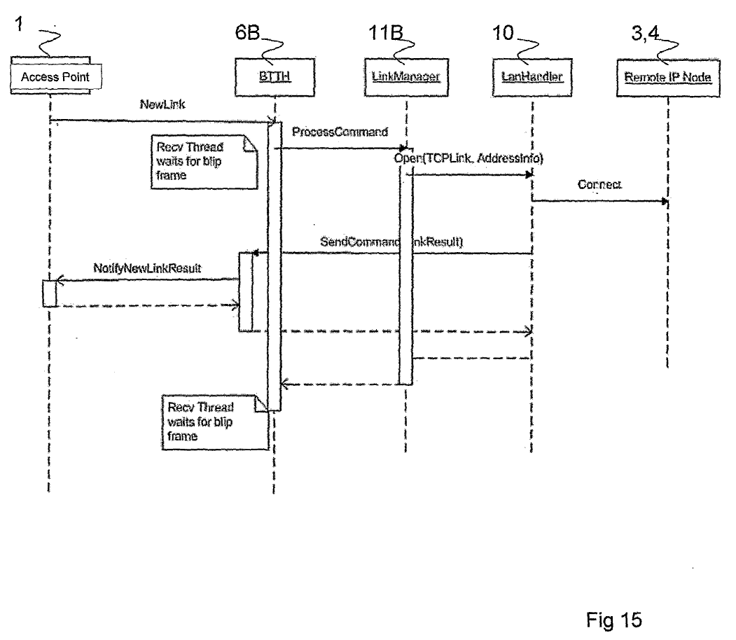

FIGS. 12 to 17 are packet sequence diagrams .

Referring first to FIG. 1, an access point 1 provides a gateway to the internet 2 to enable communications with remote terminals, internet nodes or servers 3,4 by way of the internet 2. Connections to the internet are of known form and operate in known manner to send and receive messages to and from the remote servers 3,4. Such messages (or datagrams) comprise a header and a “data payload”, the header defining the destination of the datagram as well as the return address for replies to the datagram.

The length of the header data depends on the protocol in use and may include a significant number of bytes. Some protocols try to minimise the amount of header data but the protocols all determine a particular number of fields comprising one or more bytes of data to enable the source and destination of the datagram. Other features include command data such as information required in each transmitted packet, for example when HTP requests are made.

The access point 1 therefore includes an IP (Internet Protocol) stack 5 for receiving and transmitting datagrams by way of its broadband connections to the internet 2. Communications between the access point 1 and remote devices 3,4 by way of the internet 2 are of standard format and are not described further herein since the setup and operation of such communications are well known.

One other standard operating feature of the access point 1 is a Bluetooth wireless communication arrangement 6 which allows Bluetooth equipped mobile devices (such as mobile telephone 7) to communicate with and through the access point 1. Pairing of Bluetooth equipped apparatuses with each other is also well known as is their normal operation such that these basic systems are not further described herein. Once such pairing has been accomplished however, a special controller 8 (herein BLIP Controller 8) is provided at the access point 1 to manage and improve the efficiency of communication between the access point 1 and the mobile device 7.

For the avoidance of doubt this final link between the access point 1 and the mobile device 7 need not necessarily be a Bluetooth link since the invention can be used to improve the efficiency of communications between the access point 1 and the mobile device for other kinds of final link including (but not limited to) infra red transfer, other low power radio links and other links having a limited bandwidth.

In the present case of a Bluetooth link operating with a reliable underlying Bluetooth protocol (RFCOMM-ACL) providing the basic connection only a minimal amount of additional information needs to be sent with each packet. Thus for each communication comprising a series of datagrams (or packets) between the mobile device 7 and a remote server, once the BLIP controller 8 and the mobile device 7 have initiated the communication only a few bits of data (enabling multiple applications on the same mobile device) and some very minor sequencing numbering of packets is required.

Consider then FIG. 1A which uses the basic concept of the OSI layered model, the Bluetooth layer 6A,6B being approximately equivalent to the OSI link layer providing basic framing and link synchronisation Both the client and server use the same C++ classes for these services as shown in FIG. 1A. Core classes can be seen in the diagram. The LAN handler 10 is used in the access point 1 solely where broadband connectivity is present. The link Manager 11A,11B keeps the state control of the (up to 16) virtual links, two of which may be reserved for special purposes allowing 14 usable communications links to be established at any one time across the Bluetooth connection and provides a set of common control and data primitives to the upper layers 12,13, the server and client classes. The Bluetooth Handler 6A,6B sends and receives data packets to and from the link layers whilst maintaining link integrity.

A more detailed view of the operation of the server in the access point may be seen from the Class diagram at FIG. 10 while the operation of the mobile device is shown in the detailed class diagram at FIG. 11.

By referring now to FIGS. 2 to 9, the protocols and operation of the communications between the link manager 11A,11B, and Bluetooth 6A,6B peers is considered.

The wire protocol is used in the communications so that referring to FIG. 2 and assuming that the first bit of the first byte is always transmitted first, the general format comprises a packet header of two bytes followed by a number of bytes comprising either a command sequence or a data payload. A packet will either be a command or pure data, the payload or command being of variable length to the packet maximum value which is set to 1023 bytes. The fixed limit of 1023 bytes is selected to avoid smaller data packets incurring additional packet headers. Applications requiring payloads in excess of 1023 bytes is required to handle fragmentation of the oversize data load so as not to increase the header size by requiring high or variable length payload length definition fields.

Thus as seen in FIG. 3, the header field of two bytes has the smallest possible value and uses the first four bits of byte one to provide a link identity allowing up to 16 communications across the Bluetooth link to be directed by source and destination. Link acknowledgement is not used because it is assumed that the Bluetooth connection is reliable so that packet identity and flow control techniques are not required. The next field comprised of bits 5 and 6 of the first byte is a simple sequence number used to check that the packet being received is in the correct sequence. While it assumed that the underlying Bluetooth connection is reliable, the sequence number merely ensures that if an error should occur in the handling of consecutive messages, corrective action can be taken. The sender and receiver each increment their respective counts keeping transmit and receive sequence counter in each direction (0,1,2,3,0,1,2, . . . )thus providing a sanity check of some sort on the connection. Given that the underlying connection is reliable longer sequence checks are not required. Finally, a 10 bit field (the last two bits of byte 1 plus the 8 bits of byte 2) defines the length of the payload (that is not including the 16 bits of the header) allowing up to 1023 bytes. Interleaving of packets is not used so that the Link Manager 11A, 11B can use this to receive the rest of the data (or command) in the message before looking for another packet header. Thus the sender (Access Point or Device) will always send one complete packet at a time using only 16 bits to carry up to 1023 bytes of data effectively to and from the right destination and source.

In FIG. 4 is shown the command sequences which follow the header when required. The two bytes immediately following the header may comprise a command code and version definition, the Command code indicating the operation required and the version ensuring the same level of protocol support between the access point and the device. If a device makes a request which cannot be supported by an Access Point it will return a result code indicating that the device request cannot be processed. The purpose of this is to allow constants values and behaviour to be changed in updated versions without requiring a backward compatibility with earlier versions.

Operations defined by the command code include Bad Version, NewLink, NewLink Result, LinkDown, Heartbeat and VersionError. Other operations can be added to the namespace as required.

Thus if the access point detects version incompatability for example it will return the simple packet show in FIG. 5 comprising the two byte error, command code “BadVersion” and the version field indicating the version at which the access point server is running.

In FIG. 6 the establishment of a new link between the device 7 and a destination is shown to create a new virtual link. The Access Point Server will allocate the link ID. Thus following the header and command code and version fields (4 bytes) the protocol being used between the destination host (eg 3,4) and the access point 1 will be defined. The protocol will vary depending upon the type of link being initiated by the mobile device 7. A byte is allocated to link flags which enable the device to define extra information concerning the link being established for example flagsmay indicate that the address being used is lpv4 or lpv6, the format of the address string, such as whether it is dotted (e.g. 10.1.2.3 format) or the address is a string of resolve.me.com format (DNS address type). The flags may also indicate that the link is for outgoing data only indicating that there will not be incoming data traffic for this link and that no LAN traffic will be sent through the Bluetooth connection. Other features such as Reuse Address (indicating that if the local port is in use it may be overridden and create a connection with the local port defined) are also defined in the link flags field.

Two bytes are provided in the destination length field to enable the length of the destination address to be specified while two byte source port and destination port of the device are defined in the next two fields.

Finally the destination address data is held in the last field of the data packet to enable the Access Point to set up the communication with the desired remote terminal object.

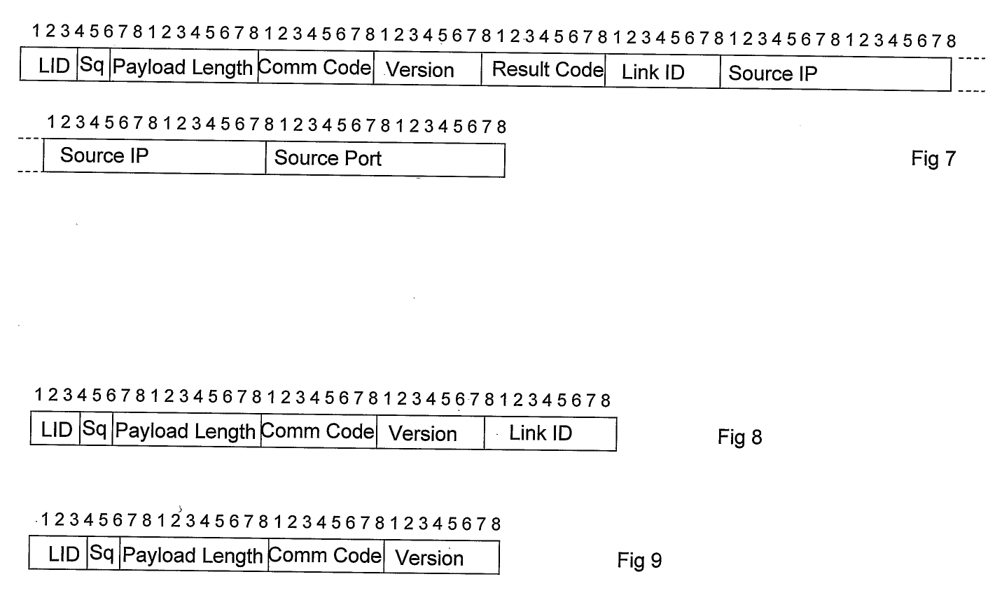

Now turning to FIG. 7, the response to a newlink command packet is a newlinkresult comprising the header and command/version fields, a result code, the link id to be used throughout the communication and reflecting the Source IP address and Source port (as defined by the destination port and address fields in the newlink command previously sent) in the final 6 bytes.

Thus the result code includes responses indicative of the response received by the access point 1 to the transmitted request and include “LinkCreationOK” which means that the link is now in operation and the link identity returned is valid;

“FailedLinkCreationDNSerror” meaning that the name given in the destination address could not be resolved;

“FailedLinkCreationNoResponse” indicating that the remote node filed to respond; or

“FailedLinkCreationNoLinks” no free links between the access point 1 and the mobile device 7 are currently available.

FIG. 8 a Link Down command message so that the command code indicates that the link identified is no longer in use. This command can be sent from the device 7 to the access point 1 as a notification that it is finished with the communication so that the server 13 can terminate the real IP communication. Alternatively if the server 13 detects that an operational link has terminated it will send this command to the mobile device 7.

Finally in FIG. 9 there is shown a simple “heartbeat” command, a simple 4 byte message sent at periodic intervals, say every 13 seconds or so, in each direction to ensure that the link is still live. Any failure to receive a heartbeat for an extended period, say 29 seconds which would indicate that two such consecutive heartbeat commands have not been received results in both the Access Point 1 and the mobile device 7 terminating the Bluetooth connection.

Referring now to FIGS. 10 and 11, the Server Class diagram (Access Point 1) and the device client Class diagram (Mobile Device 7) are considered. Both the BLIP Access Point and client device use the same the core classes of Bluetooth handler and Link Manager. Both these classes assume a controlling/reporting class adhering to a IControl interface. This interface defines a minimum set of interfaces that the controlling client or server classes must provide. In essence these are just reporting callbacks, for the client that's the IPLiteClient class and for the server IPLiteServer. The controller creates both a Bluetooth transaction handler (BTTH) and a LinkManager, and associates both handlers with each other. When employed in server mode, both handlers largely take care of things, only reporting back to the controller when the Bluetooth link totally has closed, and both objects need to be cleaned. When in client mode, the handlers report all events to the user application. The design achieves this by a user supplied call back. The implementation impacts on the design, in that it's housed in a DLL, and that DLL can be used by a number of applications. Each application creates its own logical link to the Access Point. This is necessary, otherwise each application would have to share the same user link space (i.e. be limited to 14 virtual links). The user call-back has some common fields and also a variable length payload. The common fields give back a server handle, Link ID and result code. The result code determines the contents of the payload (e.g. could be a command response or incoming data). The user application has to specify the server handle on all transactions and the link ID using link control calls or sending data.

The IPLiteClient class essentially defines the layer between the BLIP and the application, and as such gives the interface to the application. This could be changed to give each client platform its own look and feel. Additionally the LinkManager uses a number of LAN handler classes, one associated with each Link ID, to interface and control the broadband link when used with a IPLiteServer. The provision and coupling of one BTTH and LinkManager per client (or server) gives good encapsulation of one connection.

Altogether, these classes manage the IP protocol translation and control.

FIG. 11 shows the mobile device Class diagram . The server uses the client socket to index into the table of Remote Client structures, the client uses the same mechanism except the socket is the socket used to connect to the server.

Having looked at the protocol structure for the Bluetooth lite (BLIP) system and the access point and mobile device basic transactions we shall now consider the message flows for various communications which occur.

In respect of server initialisation and connection reference is now made to FIG. 12. The mobile device 7 when in range of the access point 1 which advertises the presence of its Bluetooth handling capability discovers the service and transmits a normal Bluetooth connect message to establish its presence. The access point 1 can handle up to 7 simultaneous connections from devices equipped with Bluetooth this being the current maximum specified by the protocol. The connect message is not explicitly acknowledged since if it fails the device 7 will get a Bluetooth error from the lower Bluetooth layers. Initially the server setup comprises a number of steps. The controlling application calls Open on the IPLiteServer instance. This sets up the Bluetooth service advertisement and listens for an connections. Once a device connects, a Bluetooth handler and link manager are created. The LinkManager creates some LanHandler objects, and the BTTH listens for requests on the client socket. IPLiteServer keeps a reference to both handlers in a list indexed by the client socket, and listens for another Bluetooth connection.

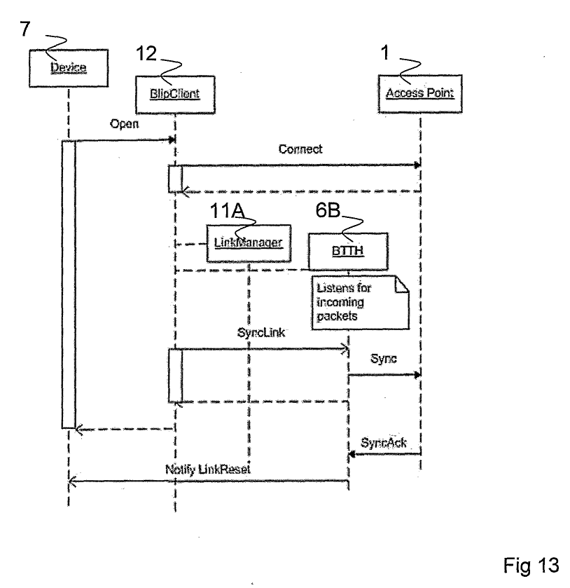

Now turning to FIG. 13, when the mobile device 7 is in range of an appropriately equipped access point 1 it may initialise by sending an open connection message to its blip client 12. The blip client 12 will then attempt to open the access point 1 Bluetooth RFCOMM connection by transmitting a connect message to the access point. The access point 1 returns an acknowledge message and then the blipclient12 creates the linkmanager 11A and Bluetooth Handler (BTTH) 6A. The Blip Client 12 then synchronises the connection by sending a syncLink message to the BTTH which sends a Sync message to the client in the Access Point 1. The BTTH then returns an acknowledgement to the blip client 12 and waits for a SyncAck message from the access point 1. Once the device 7 and the access point 1 are synchronised the BTTH sends an event code “Notify Link Reset” indicating the client and server are initialised to each other to enable future packet transfers using the BLIP protocol. Once the initialisation is complete both the server in the Access point 1 and the blip client 12 commence transmission and supervision of heartbeats as previously described.

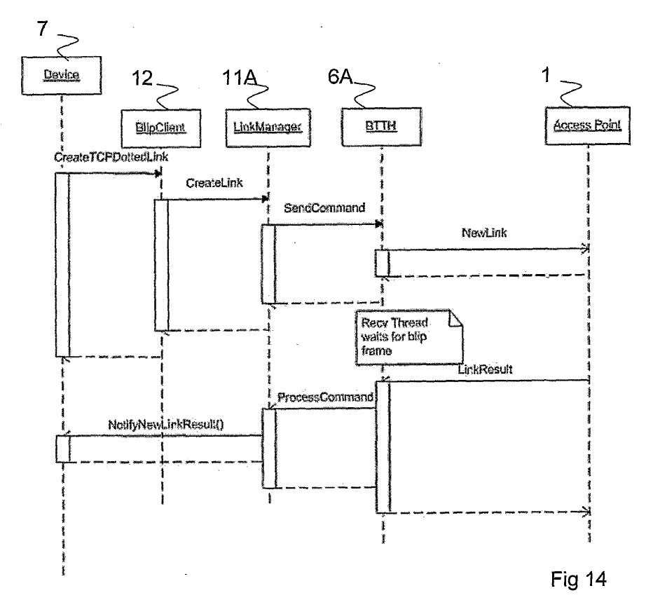

Having initialised both the mobile device 7 and the access point 1 the creation of a new link follows the process shown in FIGS. 14 & 15 respectively the device to access point and access point to remote location signal flows to which we shall now refer.

Thus at the mobile device 7 is asked by the user to obtain information from a remote site 3,4 it creates a TCP request which is transferred to its BLIP client 12. The BLIP client 12 instructs the Link Manager 11A to create a link which causes a send command message to the Bluetooth Handler 6A. This then sends a NewLink command message to the access point which is assumed acknowledged because of the underlying reliable connection.

At the access point 1 the NewLink message is received by the Bluetooth handler 6B which processes the command to the link manager 11B which forwards an Open command to the Lan Handler 10 which transmits a Command datagram by way of the communications network to the remote IP node 3,4. The LAN handler 10 returns a LinkResult command message to the Bluetooth Handler 6B which sends a NotifyNewLink result datagram back to the mobile device 7 where it is received by the Bluetooth handler 6A. The Process Command message is then sent by way of the link manager 11A and the BLIP client 12 to the device with the result. If for any reason the request fails then the client will in the alternative to receiving the NewLink command and message receive a NewLinkFailure command message and this will be handled by the device appropriately.

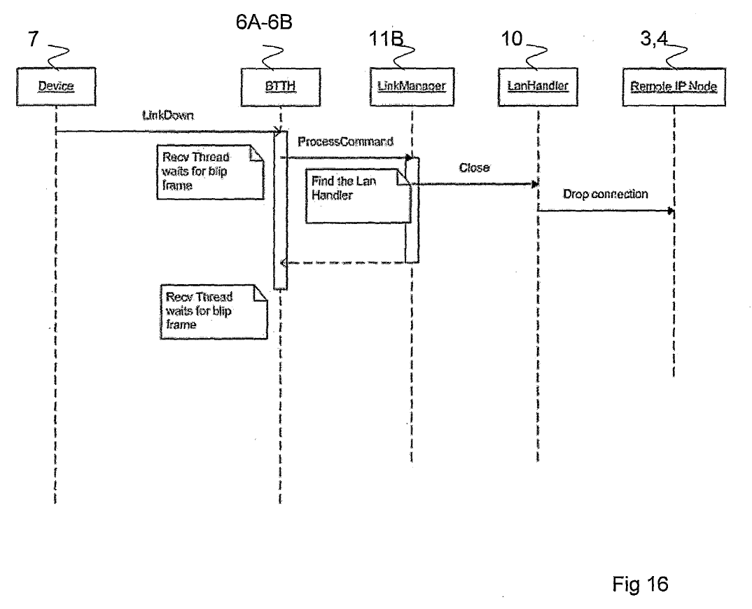

Once the link between the device and the remote IP Node has been established data transmission is a simple process of the Blip Client 12 calling the client stack and the BTTH 6A sending subsequent data packets across the link using the link manager 11A. At the Access Point 1 data packets are taken by the Bluetooth handler 6B passed to the Link Manager 11B and thence to the LAN Handler 10 with the appropriate address header information for the remote IP node 3,4. Return data packets received from the remote node 3,4 by the LAN handler 10 are returned to the link Manager 11B where the TCP headers (RTP, UDP etc) are stripped off and then the packet is transmitted by the Bluetooth handler 6B across the link to the Bluetooth handler 6A in the mobile device 7. Turning now to FIG. 16, once the user of the mobile device 7 ceases to use the remote site 3,4 or the device determines that the link is no longer required the LinkDown command is sent to the access point 1 by way of the respective Bluetooth Handlers 6A,6B and thence to the Link Manager 11B which determines the appropriate remote connection and passes a Close message to the LAN handler 10. The LAN Handler 10 then forwards a drop connection datagram to the remote site 3,4 and the Link Manager deletes the link from its records.

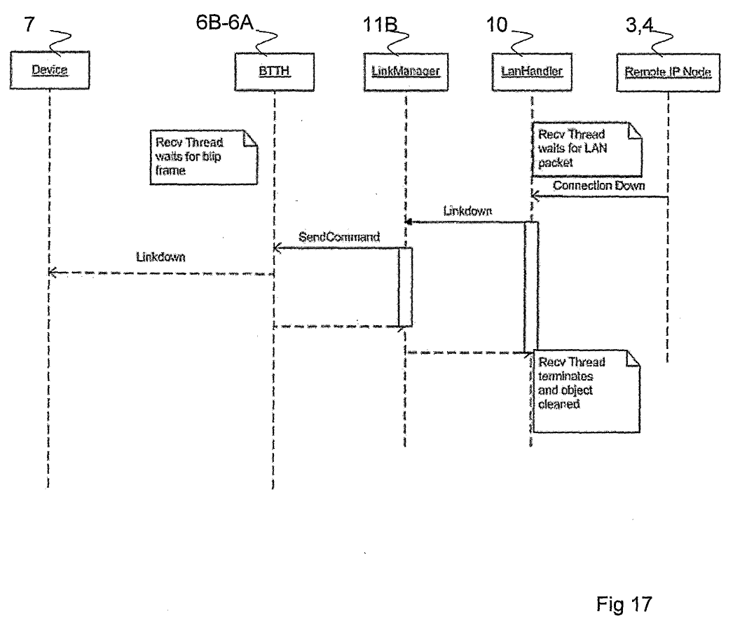

If on the other hand the remote IP node 3,4 drops the connection the process is as shown in FIG. 17. Here a connection down datagram received by way of the communications network 2 is received by the LAN Handler 10 and a LinkDown command message is sent to the Link Manager 11B which causes the LinkDown command to be sent by way of the respective Bluetooth handlers 6B,6A to the mobile device 7 for use.

Mobile device 7 and access point 1 may now enter respective clean up processes to release the link for further use.

In the event of a link failure or a heartbeat failure there is also a respective clean up process which allows the mobile device to exit from the user application in an organised manner.

While herein the headers referred to have generally been for TCP/RTP/UDP type it will also be noted that longer headers such as used in hypertext transmission (HTTP) could also be fully cached at the access point 1 in respect of a particular link. By caching the entire HTTP header very substantial savings in transmission time can be achieved. For example a header of 457 bytes would be represented by to just 4 bytes. An example of such a header could be as follows:

Frame 60 (457 bytes on wire, 457 bytes captured)
Ethernet II, Src: 00:11:43:5d:46:cf, Dst: 00:0d:72:f9:23:81
Internet Protocol, Src Addr: 192.168.1.76 (192.168.1.76), Dst Addr: 207.68.172.246 (207.68.172.246)
Transmission Control protocol, Src Port: 3301 (3301), Dst Port: http (80), Seq: 1, Ack: 1, Len: 403
Hypertext Transfer Protocol

GET / HTTP/1.1\r\n
Accept: image/gif, image/x-xbitmap, image/jpeg, image/pjpeg, application/x-shockwave-flash, */*\r\n
Accept-Language: en-gb\r\n
Accept-Encoding: gzip, deflate\r\n
User-Agent: Mozilla/4.0 (compatible; MSIE 6.0; Windows NT 5.1; SV1; .NET CLR 1.1.4322;
.NET CLR. 2.0.50215)\r\n
Host: home.microsoft.com\r\n
Connection: Keep-Alive\r\n
Cookie: MC1=GUID=9fa51b69aa5d8e4bbffd1f5ad7b49712&HASH=691b&LV=20058&V=3\r\n
\r\n

Any kind of header can be cached at the access point thus resulting in substantial savings of transmission time across the Bluetooth link form the access point 1 to the mobile device 7.

Although headers of this type mean that the initial NewLink message is more complex it is only sent once in respect of each such HTTP message and is valid for a whole series of forward and return messages. When the new link is created this is essentially a new http connection, and the common parameters would be specified, then on each individual http transaction within that connection, the savings would occur.

Specific portions of the header set up during the NewLink command phase can be used for different transactions subsequently requested by the user or device 7 in dependence upon the type of transaction and the Access Point 1 can select appropriate sections.

1. A method of operating a communication interface at a final link between a communications network and an end user device comprising the steps of
For each series of contiguous data messages establishing a link identification between the communication interface and the device;
Storing at the interface a mapping of the link identification to source and destination addresses;
For each addressed message received from the device replacing link identification information with header information corresponding to the destination; and
For each message received from a source replacing header information with link identification information
whereby the ratio of data payload to destination data of data messages in the final link is substantially improved.

2. A method of operating a communication interface as claimed in claim 1 in which the header information is cached at the interface.

3. A method of operating a communication interface as claimed in claim 1 in which the header information is sent from the end user device to the interface in a first message which establishes an additional channel from the user device to the interface where the final link has several such channels.

4. A method of operating a communication interface as claimed in claim 1 in which the final link operates with the Bluetooth protocol.

5. A communications interface at a final link between a communications network and an end user device, the interface comprising a wireless transceiver for sending data messages to and receiving data messages from the end user device, a high speed connection to a communications network for sending and receiving data messages to remote devices, and a controller, the controller establishing for each contiguous series of data messages between the end user device and a remote device a first address for messages to or from the end user device and a second address for the remote device the controller storing a mapping between the first address and the second address and on receipt of a data message from the end user device substituting the second address for the first address, and on receipt of a data message for the end user device substituting the first address for the second address, the first address comprising substantially less data than the second address whereby data payload of each message transferred over the final link to the end user device is maximized.
